(19) United States
(12) Patent Application Publication
(10) Pub. No.: US 2010/0249301 A1
(43) Pub. Date: Sep. 30, 2010

(54) Ink and manufacturing method thereof

(76) Inventor: Chang-Neng Hsiao, Taoyuan County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,842

(22) Filed: Mar. 25, 2009

(51) Int. Cl. C08K 5/07; C08L 63/00

(52) U.S. Cl. 524/361; 525/523; 524/612

(57) ABSTRACT

An ink and a manufacturing method thereof are revealed. The ink includes nanoparticles treated by wet-grinding and surface modification and ultraviolet curing resin, mixed with each other evenly. The ink is applied to manufacturing processes of ink patterns formed by screen printing and followed by chemical plating and horizontal thickening process to add up a conductive layer, especially suitable for manufacturing processes of antennas of RFID systems.

### BACKGROUND OF THE INVENTION

1. Field of the Invention

The present invention relates to an ink and a manufacturing method thereof, especially to an ink and a manufacturing method that use less amount of solid power to produce ink for reducing cost and hardening rate of the ink is increased.

2. Description of Related Art

Among manufacturing methods of conductors, there is a so-called “addition process”. After screen printing of conductive ink, the device goes through a thickening processing in horizontal lines by electroplating or chemical plating. Traditionally, most of ink used at pre-process is thermal curing conducting (metal) ink. The shortcomings of such ink include long curing time (about 10 mins at 150° C.), large energy consumption, high metal content and high cost. Thus while being applied to low-cost lines such as Radio Frequency Identification (RFID) System, it's unprofitable and will not be developed.

In order to meet requirement of dramatically reducing of manufacturing cost of low cost wiring, it is necessary to develop a kind of ink with quick hardening speed and low cost. Thus there is a need to provide a new ink that is applied to printing processes of ink pattern that is made by screen printing and followed by chemical plating and horizontal thickening processes to add up a conductive layer, especially suitable for manufacturing processes of antennas of RFID systems.

### SUMMARY OF THE INVENTION

Therefore it is a primary object of the present invention to provide an ink that contains less amount of solid powder so as to reduce cost of materials and shorten hardening time of the ink.

It is another object of the present invention to provide a manufacturing method of ink that produces solid particles at the nano-scale as main components of the ink.

It is a further object of the present invention to provide an ink that is applied to manufacturing processes of ink pattern formed by chemical plating and horizontal thickening processes.

In order to achieve above objects, the present invention provide an ink that includes nanoparticles being treated with wet grinding and surface modification, evenly mixed with ultraviolet(UV) curing resin. The ink is applied to manufacturing processes of ink pattern produced by screen printing and followed by chemical plating and horizontal thickening processes to add up a conductive layer, especially suitable for manufacturing processes of antennas of a RFID system.

During processes of wet grinding, solid powder with particle diameter ranging from 10 nm to 40 nm, 30 g to 50 g dispersants containing amino group with 10 mg to 30 mgKOH/g, and 1850-1870 g solvent such as methyl ethyl ketone are set into a ball mill to be dispersed and grinded. The effective chamber volume of the ball mill is one liter and a filling ratio of grinding media is 70%. The shear rate is 13 m/s and the total specific energy consumption is 1500 KWH/t. After dispersion, the solid content of nanoparticles of a slurry is 5% by weight and the particle size distribution D(90) is 10 nm. Then the slurry is mixed evenly with UV-curing resin in a mixer so as to get the ink.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing manufacturing process of an ink according to the present invention;

FIG. 2 is a perspective view of an embodiment applied to an antenna of a RFID system;

FIG. 3 is a cross sectional view of the embodiment applied to an antenna of a RFID system.

### DETAILED DESCRIPTION OF THE PREFERRED EMBODIMENT

Main components of ink according to the present invention include nanoparticles and UV-curing resin. The nanoparticles have features of catalyst. For example, the nanoparticles can be nano-gold, nano-silver, nano-copper, nano-palladium, nano-platinum, nano-cobalt, nano-nickel, carbon nano tube and nano carbon black. Due to large specific surface area and high surface energy, nano-particles are unstable from a thermodynamic point of view and are likely to accumulate. Thus in practice, they are separated from one another by wet-grinding in a ball mill. And with surface modification, nanoparticle agglomeration is reduced and is more compatible with the UV-curing resin. The factors for resin selection to be considered include solubility in solvents and resistance against acidic and alkali solutions so as to avoid environmental impact after being coated. The UV-curing resin is selected from one of the followings: epoxy, polyurethane (PU), acrylic resin, and silyl resin. Due to high specific surface area and high catalytic activity, the amount of nanoparticles being added is quite low. Thus the cost is reduced. Moreover, the resin used is UV curing resin so that the hardening of the ink is getting fast.

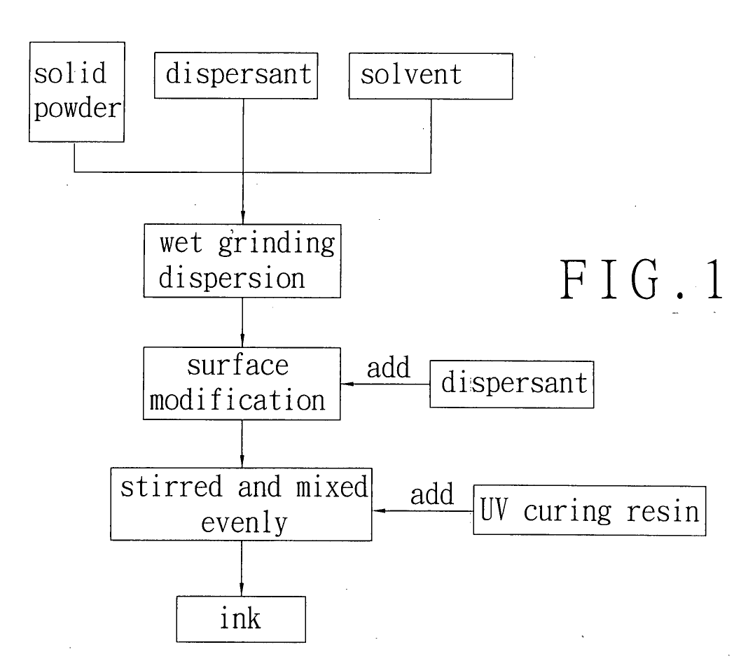

Furthermore, a manufacturing method of the ink includes at least the following steps, as shown in FIG. 1:
Step (a): wet grinding, dispersion and surface modification; put solid powder, dispersants, and solvent into a ball mill for wet grinding and dispersion. Then dispersants are added to run surface modification at the same time for production of slurry containing nanoparticles with solid content; and
Step (b) stirring and mixing; the slurry is stirred and mixed evenly with the UV curing resin at a certain ratio in a mixer so as to obtain the ink.

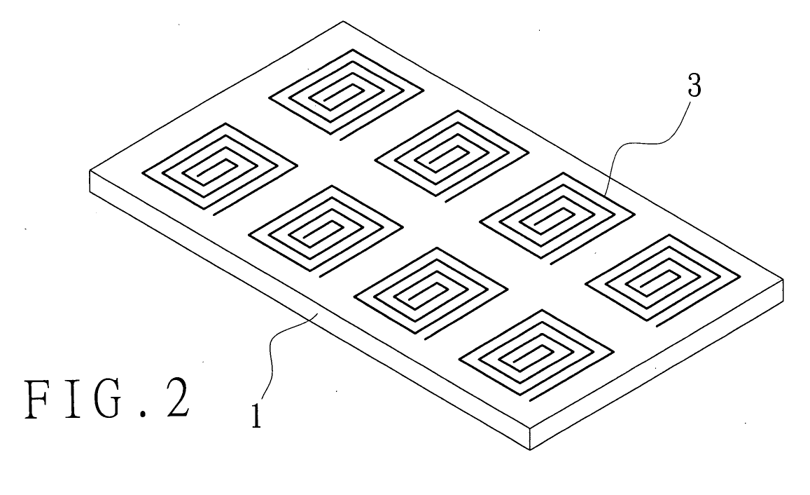

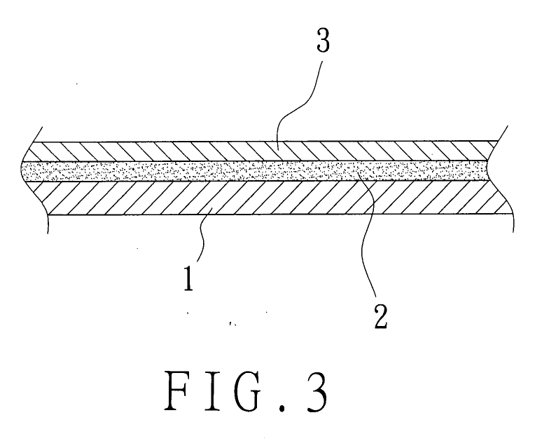

The manufacturing processes of the ink pattern are especially suitable for being applied to manufacturing processes of antennas of RFID systems, as shown in FIG. 2. With reference of FIG. 3, a layer of ink pattern (2) is printed on PET (polyethylene terephthalate) substrate (1) by screen printing. Then a metal conductive layer (3) is formed on the ink pattern layer (2) by chemical plating so as to form antennas of a RFID system.

In the step of wet grinding, dispersion and surface modification, diameter of the solid powder being wet grinded and surface modified in the ball mill ranges from 1 to 100 nm and 10-30 nm is preferred. The dispersants are 30 g to 50 g, containing amino group with 10-30 mgKOH/g. The solvent is 1850-1870 g methyl ethyl ketone. The effective chamber volume of the ball mill is one liter, the diameter of grinding media ranges from 0.1 mm to 0.5 mm, and a filling ratio of grinding media is 50-80%. The grinding media is yttria stabilized zirconia (YSZ). The shear rate is 13 m/s and the total specific energy consumption is 1500 KWH/t. After grinding and dispersion, the solid content of nanoparticles of a slurry is 0.01% to 5% by weight while the optimal solid content is 5 wt %. The particle size distribution D(90) is 10 nm.

### Embodiment One

Take some silver powder whose particle diameter ranges from 10 to 30 nm, 10 g dispersant containing amino group with 10 mgKOH/g and 1870 g methyl ethyl ketone. Put them into a ball mill for grinding and dispersion. As to the ball mill, the effective chamber volume is one liter, a filling ratio of grinding media is 70%, the shear rate is 13 m/s and the total specific energy consumption is 1500 KWH/t. After dispersion, the solid content of nanoparticles of a slurry is 5 wt % and the particle size distribution D(90) is 10 nm.

Take 1 g dispersed slurry and add with 9 g UV curing epoxy resin to be mixed evenly in a mixer so as to obtain the ink of the present invention. The solid content of nano-silver is 0.5% of the ink by weight while the viscosity of the ink is 400 cps measured by BROOKFIELD VE-D viscometer (spindle 1, 20 rpm, room temperature 20° C.).

### Embodiment Two

Take some nickel powder whose particle diameter ranges from 20 to 40 nm, 50 g dispersant containing amino group with 10 mgKOH/g and 1850 g methyl ethyl ketone. Put them into a ball mill for grinding and dispersion. As to the ball mill, the effective chamber volume is one liter, a filling ratio of grinding media is 70%, the shear rate is 13 m/s and the total specific energy consumption is 1500 KWH/t. After dispersion, the solid content of nanoparticles of a slurry is 5 wt % and the particle size distribution D(90) is 10 nm.

Take 1 g dispersed slurry and add with 9 g UV curing epoxy resin to be mixed evenly in a mixer so as to obtain the ink of the present invention. The solid content of nanonickel is 0.5% of the ink by weight while the viscosity of the ink is 400 cps measured by BROOKFIELD VE-D viscometer (spindle 1, 20 rpm, room temperature 20° C.).

In summary, the ink is formed by nanoparticles being wet grinded and surface modified, and UV curing resin, mixed evenly with each other. The ink is applied to manufacturing processes of ink pattern produced by screen printing and followed by chemical plating and horizontal thickening processes to add up a conductive layer, especially suitable for manufacturing processes of antennas of a RFID system.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An ink comprising:
nanoparticles with catalytic properties; and
Ultraviolet (UV) curing resin, mixed evenly with each other.

2. The ink as claimed in claim 1, wherein the nanoparticles are made of nanogold, nanosilver, nanocopper, nanopalladium, nanoplatinum, nanocobalt, nanonickel, carbon nano tube or nano carbon black.

3. The ink as claimed in claim 1, wherein the UV curing resin is epoxy, polyurethane (PU), acrylic resin, or silyl resin.

4. A manufacturing method of an ink comprising the steps of:
(a) wet grinding, dispersing and surface modifying; setting solid powder, at least one dispersant, and solvent into a ball mill to be wet grinded and dispersed while surface modification is running at the same time for production of slurry containing nanoparticles with solid content;
(b) stirring and mixing; stirring and mixing the slurry evenly with UV curing resin in a mixer so as to obtain the ink.

5. The method as claimed in claim 4, wherein in the step of wet grinding, dispersing and surface modifying, diameter of the solid powder to be wet grinded and dispersed in the ball mill ranges from 1 nm to 100 nm, the dispersant is 30 g to 50 g, and the solvent is 1850 g to 1870 g.

6. The method as claimed in claim 5, wherein optimal diameter of the solid powder ranges from 10 nm to 30 nm.

7. The method as claimed in claim 5, wherein effective chamber volume of the ball mill is one liter, diameter of grinding media ranges from 0.1 mm to 0.5 mm, a filling ratio of grinding media is 50-80%, a shear rate of the ball mill is 13 m/s and total specific energy consumption of the ball mill is 1500 KWH/t.

8. The method as claimed in claim 7, wherein the grinding media is yttria stabilized zirconia (YSZ).

9. The method as claimed in claim 5, wherein the solid content of the nanoparticles is 0.01% to 5% by weight.

10. The method as claimed in claim 9, wherein the optimal solid content of the nanoparticles is 5% by weight.

11. The method as claimed in claim 4, wherein the nanoparticles are made of nanogold, nanosilver, nanocopper, nanopalladium, nanoplatinum, nanocobalt, nanonickel, carbon nano tube or nano carbon black.

12. The method as claimed in claim 4, wherein the UV curing resin is epoxy, polyurethane (PU), acrylic resin, or silyl resin.

13. The method as claimed in claim 5, wherein the dispersant having amino group with 10 mg to 30 mgKOH/g.

14. The method as claimed in claim 5, wherein the solvent is methyl ethyl ketone.
